(19) United States
(12) Patent Application Publication
(10) Pub. No.: US 2024/0376307 A1
(43) Pub. Date: Nov. 14, 2024

(54) COMPOSITION, ADHESIVE, AND JOINED BODY

(71) Applicant: DENKA COMPANY LIMITED, Tokyo (JP)

(72) Inventors: Hideki HAYASHI, Tokyo (JP); Hiroyuki KURIMURA, Tokyo (JP)

(73) Assignee: DENKA COMPANY LIMITED, Tokyo (JP)

(21) Appl. No.: 18/691,557

(22) PCT Filed: Sep. 26, 2022
(86) PCT No.: PCT/JP2022/035610

§ 371 Date: Mar. 13, 2024

(30) Foreign Application Priority Data
Sep. 29, 2021 (JP) 2021-159268

(51) Int. Cl. C08L 51/00; C08K 5/098; C08L 9/02; C09J 5/04; C09J 11/06; C09J 109/02; C09J 151/00

(52) U.S. Cl. CPC C08L 51/003; C08K 5/098; C08L 9/02; C09J 5/04; C09J 11/06; C09J 109/02; C09J 151/003; C08L 2207/53; C09J 2301/414; C09J 2409/00; C09J 2433/00

(57) ABSTRACT

A two-agent type composition consisting of first agent and second agent, wherein: first agent contains an elastomer, a first and second acrylic component, a second acrylic component, and a polymerization initiator; second agent contains condensate of amine and aldehyde, third acrylic component, and reducing agent; the first acrylic component is (meth)acrylate or (meth)acrylic acid, containing two or more hydroxyl groups bonded to a carbon atom in one molecule, or containing one or more functional groups of one or more kind of functional groups selected from group consisting of an amide group, a cyclic amide group, a sulfoxide group, a ketone group, an aldehyde group, a sulfo group, a sulfino group, a phosphonic group, a sulfobetaine group, a carbobetaine group, and a phosphobetaine group in one molecule; second acrylic component is a (meth)acrylate or (meth)acrylic acid other than first acrylic component; and the third acrylic component is (meth)acrylate or (meth)acrylic acid.

### TECHNICAL FIELD

The present invention relates to a composition, an adhesive, and a joined body.

### BACKGROUND ART

The demand for adhesives that are cured in a short time at room temperature is increasing from the viewpoint of improving production line efficiency and cost reduction. Well-known room temperature fast-curing type adhesives include two-component fast-curing type epoxy adhesives, instantaneous adhesives, anaerobic adhesives, and non-anaerobic acrylic adhesives.

The two-component fast-curing type epoxy adhesives are used by measuring and mixing a main agent and a curing agent, and there was a risk of significant strength loss if the measuring and mixing was not performed sufficiently. In addition, even if the measuring and mixing was performed sufficiently, there was a problem of low peeling strength and low impact strength.

On the one hand, since the instantaneous adhesives have excellent workability but generally have low peeling strength and low impact strength and are inferior in heat resistance and moisture resistance, the range of use was significantly limited.

On the other hand, since the anaerobic adhesives are adhesives that are cured by blocking air by crimping the adhesive between the materials to be adhered, it is natural that the parts in contact with air, such as overflowed parts, are not cured. Therefore, if adherends are porous or the balance between adherends is bad, the adhesive is not cured sufficiently, resulting in adhesion defects.

In contrast, the non-anaerobic acrylic adhesives, generally referred to as second-generation acrylic adhesives (SGA), have started to be used widely because they are two-component type but do not require accurate measurement of the two components, have excellent workability that they are cured at room temperature in several minutes to several tens of minutes with extremely rough measuring and mixing, and have high peeling strength and high impact strength as well as good curing of the overflowed parts.

For example, it is reported in Patent Literature 1 that, in a nitrile butadiene rubber component, controlling the content of the acrylonitrile monomer unit in 100 parts by mass of the nitrile butadiene rubber component to 5 to 30 parts by mass can improve the durability and can prevent a corrosion reaction such as oxidation of the adherend when a metal such as copper is used as the adherend, achieving higher adhesive strength.

In addition, it is reported in Patent Literature 2 that it is possible to promote fast curing of the adhesive by adopting a compound having an enal structure and a compound having an amine structure, and, in the nitrile butadiene rubber component, controlling the content of the acrylonitrile monomer unit in 100 parts by mass of the nitrile butadiene rubber component to 10 to 30 parts by mass can improve the durability.

Further, it is reported in Patent Literature 3 that, in a one-component acrylic adhesive, albeit not two-component type, the adhesive strength can be improved by using at least one kind of oligomer having two or more (meth)acrylic groups in the molecule, and (meth)acrylate modified liquid rubber is an example of the oligomer.

### CITATION LIST

### Patent Literature

[Patent Literature 1] JP-A-2009-197160
[Patent Literature 2] WO2010/041710
[Patent Literature 3] JP-A-2021-123655

### SUMMARY OF INVENTION

### Technical Problem

An object of the present invention is to provide a composition that can be used for an adhesive with excellent fast-curing property and heat cycle resistance.

### Solution to Problem

The inventors have conducted studies, and have found that a two-agent type composition, wherein: the first agent contains an elastomer (A), a first acrylic component (B), a second acrylic component (C), and a polymerization initiator (D); the second agent contains a condensate of amine and aldehyde (E), a third acrylic component (F), and a reducing agent (G); the first acrylic component (B) is a (meth)acrylate or (meth)acrylic acid, containing two or more hydroxyl groups bonded to a carbon atom in one molecule, or containing one or more functional groups of one or more kind of functional groups selected from a group consisting of an amide group, a cyclic amide group, a sulfoxide group, a ketone group, an aldehyde group, a sulfo group, a sulfino group, a phosphonic group, a sulfobetaine group, a carbobetaine group, and a phosphobetaine group in one molecule; the second acrylic component (C) is a (meth)acrylate or (meth)acrylic acid other than the first acrylic component (B); and the third acrylic component (F) is a (meth)acrylate or (meth)acrylic acid, can significantly improve fast-curing property and heat cycle resistance if the two-agent type composition is used for an adhesive.

That is, the present invention relates to:
(1) a two-agent type composition consisting of a first agent and a second agent, wherein: the first agent contains an elastomer (A), a first acrylic component (B), a second acrylic component (C), and a polymerization initiator (D); the second agent contains a condensate of amine and aldehyde (E), a third acrylic component (F), and a reducing agent (G); the first acrylic component (B) is a (meth)acrylate or (meth)acrylic acid, containing two or more hydroxyl groups bonded to a carbon atom in one molecule, or containing one or more functional groups of one or more kind of functional groups selected from a group consisting of an amide group, a cyclic amide group, a sulfoxide group, a ketone group, an aldehyde group, a sulfo group, a sulfino group, a phosphonic group, a sulfobetaine group, a carbobetaine group, and a phosphobetaine group in one molecule; the second acrylic component (C) is a (meth)acrylate or (meth)acrylic acid other than the first acrylic component (B); and the third acrylic component (F) is a (meth)acrylate or (meth)acrylic acid,
(2) the composition of (1), wherein the condensate of amine and aldehyde (E) is aldehydeaniline,
(3) the composition of (1) or (2), wherein the first acrylic component (B) is a (meth)acrylate or (meth)acrylic acid containing two or more hydroxyl groups bonded to a carbon atom in one molecule, or containing one or more functional groups of one or more kind of functional groups selected from a group consisting of a ketone group, an aldehyde group, a sulfoxide group, a sulfo group, a sulfino group, a sulfobetaine group, a carbobetaine group, a phosphonic group, and a phosphobetaine group in one molecule,
(4) the composition of any one of (1) to (3), wherein a content of the first acrylic component (B) is 10 to 40 parts by mass when a total of the first acrylic component (B) and the second acrylic component (C) is 100 parts by mass,
(5) the composition of any one of (1) to (4), wherein a content of a monofunctional (meth)acrylate or (meth)acrylic acid in the first acrylic component (B) and the second acrylic component (C) is 70 to 100 parts by mass when a total of the first acrylic component (B) and the second acrylic component (C) is 100 parts by mass,
(6) the composition of any one of (1) to (5), wherein a content of the elastomer (A) is 30 to 70 parts by mass when a total of the first acrylic component (B) and the second acrylic component (C) is 100 parts by mass,
(7) the composition of any one of (1) to (6), wherein: one or more kind of elastomer components contained in the elastomer (A) is a liquid elastomer (A1); and the liquid elastomer (A1) is in a liquid state under an atmosphere at 23° C.,
(8) the composition of any one of (1) to (7), wherein the elastomer (A) contains one or more kind of NBRs,
(9) the composition of (8), wherein the one or more kind of NBRs contains two or more kind of NBRs with different nitrile contents,
(10) the composition of any one of (1) to (9), wherein a nitrile content in the elastomer (A) is 0.001 to 0.300 parts by mass in 100 parts by mass of the elastomer (A),
(11) the composition of any one of (1) to (10), wherein: the elastomer (A) contains a core-shell type graft copolymer (A2); and a content of the core-shell type graft copolymer (A2) is 0 to 10 parts by mass when a total of the first acrylic component (B) and the second acrylic component (C) is 100 parts by mass,
(12) the composition of any one of (1) to (11), wherein the elastomer (A) contains a (meth)acryloyl modified elastomer (A3),
(13) the composition of any one of (1) to (12), wherein a viscosity of the first agent at 25° C. is 1,000 to 100,000 mPa·s,
(14) the composition of any one of (1) to (13), containing 0.001 to 3 parts by mass of a fluorine-containing (meth)acrylate or fluorine-containing (meth)acrylic acid (F1) in 100 parts by mass of the third acrylic component (F),
(15) the composition of any one of (1) to (14), wherein the reducing agent (G) is a transition metal salt.
(16) the composition of any one of (1) to (15), further containing a stabilizer (H) in the second agent,
(17) the composition of (16), a content of the stabilizer (H) is 0.001 to 0.5 parts by mass when a total of the condensate of amine and aldehyde (E), the third acrylic component (F), and the reducing agent (G) is 100 parts by mass,
(18) the composition of (16) or (17), wherein the stabilizer (H) contains a stable radical type compound having a stable radical,
(19) the composition of (18), wherein the stable radical of the stable radical type compound is a nitroxide radical,
(20) the composition of (18) or (19), wherein the stable radical type compound contains at least one kind selected from a group consisting of 1-oxyl-2,2,6,6-tetramethylpiperidine, 4-hydroxy-2,2,6,6-tetramethylpiperidine 1-oxyl, and 4-methacryloyloxy-2,2,6,6-tetramethylpiperidine 1-oxyl,
(21) an adhesive containing the composition of any one of (1) to (20),
(22) an adhesive for speakers or an adhesive for motors, containing the composition of any one of (1) to (20), and
(23) a joined body joined by the composition of any one of (1) to (20).

### Advantageous Effects of Invention

According to the present invention, a composition that can be used for an adhesive with excellent fast-curing property and heat cycle resistance can be provided.

### DESCRIPTION OF EMBODIMENTS

### Explanation of Terms

In the present specification, for example, the description “A to B” means being equal to or greater than A and being equal to or less than B.

In the present specification, the description “(meth)acrylate or (meth)acrylic acid” includes the case where only (meth)acrylate is contained, the case where only (meth)acrylic acid is contained, and the case where both (meth)acrylate and (meth)acrylic acid are contained.

In the present specification, the description “acrylic component” includes the case where only the acrylic component is contained, the case where only the methacrylic component is contained, and the case where both the acrylic component and the methacrylic component are contained.

Hereinafter, embodiments of the present invention will be explained in detail. The present invention is not limited thereto, and various variations may be made without departing from the scope of the invention. Various distinctive features shown in the following embodiments can be combined with each other. In addition, an invention can be established independently for each of the distinctive features.

### <Two-Agent Type Composition>

The two-agent type composition according to the present embodiment is consisting of a first agent and a second agent, in which: the first agent contains an elastomer (A), a first acrylic component (B), a second acrylic component (C), and a polymerization initiator (D); the second agent contains a condensate of amine and aldehyde (E), a third acrylic component (F), and a reducing agent (G); the first acrylic component (B) is a (meth)acrylate or (meth)acrylic acid, containing two or more hydroxyl groups bonded to a carbon atom in one molecule, or containing one or more functional groups of one or more kind of functional groups selected from a group consisting of an amide group, a cyclic amide group, a sulfoxide group, a ketone group, an aldehyde group, a sulfo group, a sulfino group, a phosphonic group (phosphonic acid group), a sulfobetaine group, a carbobetaine group, and a phosphobetaine group in one molecule; the second acrylic component (C) is a (meth)acrylate or (meth)acrylic acid other than the first acrylic component (B); and the third acrylic component (F) is a (meth)acrylate or (meth)acrylic acid.

Hereinafter, each component contained in the first agent and the second agent will be explained.

### <Elastomer (A)>

The two-agent type composition according to the present embodiment contains the elastomer (A) in the first agent. Examples of the elastomer (A) include various rubbers such as nitrile butadiene rubbers (NBR), butadiene rubbers, acrylic rubbers, and urethane rubbers; and graft copolymers and the like such methyl methacrylate-butadiene-styrene-based graft copolymers (butadiene/MMA/ST copolymers), (meth)acrylate-butadiene-(meth)acrylonitrile-styrene copolymers, and acrylonitrile-butadiene-styrene-based graft copolymers.

As for the elastomer (A) according to the present embodiment, one of these elastomers may be used alone, or two or more of these may be used in combination.

From the viewpoint of improving heat cycle resistance, the content of the elastomer (A) in the two-agent type composition according to the present embodiment is preferably 30 to 70 parts by mass, and more preferably 30 to 50 parts by mass, when the total of the first acrylic component (B) and the second acrylic component (C) is 100 parts by mass. The content of the elastomer (A) is, specifically for example, 30, 35, 40, 45, 50, 55, 60, 65, or 70 parts by mass, and may be in the range between the two values exemplified herein. It should be noted that the content of the elastomer (A) means the total amount of the elastomer (A) used in combination when the elastomer (A) is used in combination.

### <Liquid Elastomer (A1)>]

As for the two-agent type compositions according to the present embodiment, one or more kind of the elastomers (A) contains a liquid elastomer (A1) from the viewpoint of improving heat cycle resistance while taking workability (adhesive applicability) into consideration. Here, “liquid” in the present invention means that the elastomer exhibits a liquid state at room temperature (23° C.). Specifically, it means what is determined to be liquid in accordance with the test in “ASTM D 4359-90: Standard Test Method for Determining Whether a Material is a Liquid or Solid”.

In addition, the viscosity of the liquid elastomer (A1) measured at 27° C. using a BH viscometer is preferably 100,000 to 400,000 mPa·s, and more preferably 200,000 to 300,000 mPa·s. It is, specifically for example, 100,000, 150,000, 200,000, 250,000, 300,000, 350,000, or 400,000 mPa·s, and may be in the range between the two values exemplified herein.

Examples of the liquid elastomer (A1) according to the present embodiment include liquid nitrile butadiene rubber (NBR) and liquid butadiene rubber (BR). Liquid nitrile butadiene rubber (NBR) is preferred from the viewpoint of toughness.

A (meth)acryloyl modified elastomer (A3) may be used as the liquid elastomer (A1) according to the present embodiment.

As for the liquid elastomer (A1) according to the present embodiment, one of these liquid elastomers may be used alone, or two or more of these may be used in combination.

As the liquid elastomer (A1), for example, “HYPRO (registered trademark) 1300X33LC VTBNX” made by Huntsman Corporation can be mentioned as a commercially available product.

From the viewpoint of improving heat cycle resistance, the content of the liquid elastomer (A1) in the two-agent type composition according to the present embodiment is preferably 1 to 50 parts by mass, and more preferably 10 to 40 parts by mass, when the total of the first acrylic component (B) and the second acrylic component (C) is 100 parts by mass. The content of the liquid elastomer (A1) is, specifically for example, 1, 5, 10, 15, 20, 25, 30, 35, 40, or 50 parts by mass, and may be in the range between the two values exemplified herein. It should be noted that the content of the liquid elastomer (A1) means the total amount of the liquid elastomer (A1) used in combination when the liquid elastomer (A1) is used in combination.

As for the two-agent type composition according to the present embodiment, the content of the liquid nitrile butadiene rubber (NBR) is preferably 80 parts by mass or less, and more preferably 30 to 65 parts by mass, in 100 parts by mass of the elastomer (A).

### <Nitrile Butadiene Rubber (NBR)>

The two-agent type composition according to the present embodiment preferably contains nitrile butadiene rubber (NBR) as the elastomer (A). Nitrile butadiene rubber (NBR) is a polymer having (meth)acrylonitrile and 1,3-butadiene as its constituent units and having rubbery elasticity at room temperature, and can be obtained by copolymerizing butadiene and (meth)acrylonitrile. Since nitrile butadiene rubber (NBR) is contained in combination with other components, toughness can be expected. Examples of NBR include solid NBR and liquid NBR. It should be noted that the “solid NBR” herein refers to NBR that does not correspond to the above-mentioned “liquid NBR”.

### <Nitrile Content of NBR>

The two-agent type composition according to the present embodiment preferably contains two or more kind of NBRs with different nitrile contents from the viewpoint of improving heat cycle resistance while taking workability (adhesive applicability) into consideration. The nitrile content of NBR is the content (parts by mass) of (meth)acrylonitrile monomer unit in 100 parts by mass of NBR. From the viewpoint of improving heat cycle resistance, each nitrile content of NBR is preferably 1 to 70 parts by mass, and more preferably 15 to 60 parts by mass, in 100 parts by mass of NBR. It is, specifically for example, 1, 3, 5, 10, 15, 20, 25, 30, 35, 40, 45, 50, 55, 60, 65, or 70 parts by mass, and may be in the range between the two values exemplified herein.

When the two-agent type composition according to the present embodiment contains two or more kind of NBRs with different nitrile contents, the nitrile content of the NBR with higher nitrile content is preferably 20 to 40 parts by mass, and more preferably 30 to 35 parts by mass in 100 parts by mass of NBR from the viewpoint of toughness.

In addition, the nitrile content of the NBR with lower nitrile content is preferably 1 to 39 parts by mass, and more preferably 15 to 34 parts by mass in 100 parts by mass of NBR from the viewpoint of improving heat cycle resistance.

When the two-agent type composition according to the present embodiment contains two or more kind of NBRs with different nitrile contents, the difference between the nitrile content of the NBR with higher nitrile content and that of the NBR with lower nitrile content is preferably 0.1 to 25 parts by mass, and more preferably 10 to 20 parts by mass in 100 parts by mass of NBR from the viewpoint of improving heat cycle resistance while taking workability (adhesive applicability) into consideration.

### <Nitrile Content in Elastomer (A)>

As for the two-agent type composition according to the present embodiment, the nitrile content in the elastomer (A) is preferably 0.001 to 0.300 parts by mass, and more preferably 0.003 to 0.275 parts by mass in 100 parts by mass of the elastomer (A) from the viewpoint of improving heat cycle resistance while taking workability (adhesive applicability) into consideration. It is, specifically for example, 0.001, 0.010, 0.100, 0.200, 0.210, 0.220, 0.230, 0.240, 0.250, 0.260, 0.270, 0.280, 0.290, or 0.300 parts by mass, and may be in the range between the two values exemplified herein.

The nitrile content in the elastomer (A) herein means the acrylonitrile monomer unit contained in the elastomer (A). The acrylonitrile monomer unit is, for example, what is contained in NBR or MBAS resin in the elastomer (A).

### <Method of Measuring Nitrile Content>

In the two-agent type composition according to the present embodiment, the nitrile content in the elastomer (A) can be measured in accordance with JISK6451-2.

In addition, the fact that multiple kinds of NBR with different nitrile contents are contained in the composition can be confirmed by the blending ratio of the NBRs used.

The nitrile content can be controlled by adjusting the blending amounts of acrylonitrile and 1,3-butadiene that are constituent units in the production of the NBR used.

<Core-Shell Type Graft Copolymer (A2)>

The two-agent type composition according to the present embodiment preferably contains a core-shell type graft copolymer (A2) from the viewpoint of imparting thixotropy. The core-shell type graft copolymer means a graft copolymer in which a polymer as a shell component is grafted into a cross-linked rubber as a core component.

### <Core Component>

Examples of the main component of the cross-linked rubber as the core component include butadiene rubber, styrene-butadiene rubber, butyl rubber, ethylene-propylene-diene rubber, isobutylene polymer rubber, ethylene-vinyl acetate copolymer rubber, isobutylene rubber, chloroprene rubber, and nitrile rubber. Among these, the cross-linked rubber consisting mainly of butadiene and/or the cross-linked rubber consisting mainly of styrene-butadiene is/are preferable. As the cross-linked rubber consisting mainly of butadiene, known butadiene rubbers can be used. As the cross-linked rubber consisting mainly of styrene-butadiene, known styrene-butadiene rubbers can be used. One of these rubbers may be used alone, or two or more of these may be used in combination.

Further, the core component may contain other optional components to the extent that the effect of the present invention is not hindered. The content of the optional component is preferably 70 parts by mass or less, preferably less than 70 parts by mass, more preferably 50 parts by mass or less, and more preferably less than 50 parts by mass in 100 parts by mass of the core component.

### <Shell Component>

The shell component is preferably consisting mainly of a homopolymer or copolymer in which one or more kind of monomers selected from the group consisting of (meth)acrylate monomer, (meth)acrylonitrile, and vinyl-based monomer having a double bond are grafted.

Examples of the (meth)acrylate monomer used for the shell component include monofunctional (meth)acrylates. Among these monofunctional (meth)acrylates, alkyl (meth)acrylate is preferred, and methyl (meth)acrylate is more preferred.

Examples of the vinyl-based monomer having a double bond used for the shell component include styrene, α-methylstyrene, p-methylstyrene, p-methoxystyrene, and divinylbenzene. One of these can be used alone, or two or more of these can be used in combination. Among these vinyl-based monomers having a double bond, styrene is preferred.

Among shell components, (meth)acrylate monomer is preferred from the viewpoint of swelling.

Examples of the core-shell type graft copolymer (A2) include a (meth)acrylate-butadiene-styrene copolymer (hereinafter referred to as MBS resin) obtained by graft copolymerizing (meth)acrylate as well as, if necessary, styrene as the shell component with the core component that is a cross-linked rubber of butadiene and/or a cross-linked rubber of styrene-butadiene; a (meth)acrylate-butadiene-(meth)acrylonitrile-styrene copolymer (hereafter referred to as MBAS resin) obtained by graft copolymerizing the (meth)acrylate as well as, if necessary, styrene and (meth) acrylonitrile as the shell component with the core component that is a cross-linked butadiene rubber and/or a styrene-butadiene rubber; and an acrylonitrile-butadiene-styrene copolymer (hereinafter referred to as ABS resin) obtained by graft copolymerizing acrylonitrile and styrene as the shell component with the core component that is a cross-linked rubber of butadiene and/or a cross-linked rubber of styrene-butadiene. Among these, the MBAS resin is preferred from the viewpoint of toughness and curability.

As for the core-shell type graft copolymer (A2) according to the present embodiment, one of these core-shell type graft copolymers (A2) may be used alone, or two or more of these may be used in combination.

Examples of the MBS resin include KaneAce B series (made by KANEKA CORPORATION), BTA series (made by Rohm and Haas), and METABLEN series (made by MITSUBISHI RAYON CO., LTD.). Examples of the MBAS resin include BL-20 (made by Denka Company Limited). Examples of the ABS resin include DENKA ABS (made by Denka Company Limited).

The content ratio of each component in the core-shell type graft copolymer (A2) is preferably 5 to 30 parts by mass of (meth)acrylate, 40 to 80 parts by mass of butadiene, and 10 to 40 parts by mass of other vinyl-based monomer in 100 parts by mass of the copolymer (preferably, in 100 parts by mass of the total of (meth)acrylate, butadiene, and other vinyl-based monomer), more preferably 10 to 25 parts by mass of (meth)acrylate, 40 to 75 parts by mass of butadiene, and 10 to 40 parts by mass of other vinyl-based monomer, and most preferably 13 to 25 parts by mass of (meth)acrylate, 45 to 75 parts by mass of butadiene, and 0 to 30 parts by mass of other vinyl-based monomer. Other vinyl monomer means a monomer other than (meth)acrylate or butadiene. Examples of other vinyl monomer include (meth)acrylonitrile, styrene, and divinylbenzene. Among these, (meth)acrylonitrile and/or styrene are/is preferred. If the content ratio of each component in the core-shell type graft copolymer (A2) is within the range of the present invention, toughness can be expected.

The method of producing the core-shell graft copolymer (A2) is not particularly limited, and known techniques such as emulsion polymerization using an aqueous dispersing medium and an emulsifier can be used.

When a radical monomer is used as a constituent of the core component, ordinary emulsion polymerization can be applied. When a radical-poor monomer is used, a method of emulsifying and dispersing a prepolymer obtained by ionic polymerization such as cationic polymerization, anionic polymerization, and coordination polymerization in an aqueous dispersing medium can be applied. When producing a particle type graft copolymer containing a plurality of polymer components in the same particle, the following methods and the like can be used to produce the core component: a method in which each monomer component is uniformly mixed in advance and then emulsified and dispersed to perform the reaction; a method in which seed particles consisting of a single polymer component are additionally polymerized with other components (seed polymerization); and a method of mixing particles consisting of a single polymer component and adding acid (hydrochloric acid or the like) or salt (sodium sulfate or the like) to agglomerate and enlarge the particles. At this time, the morphology (phase structure) inside the particle obtained can be controlled by the production method, ratio of each component, order of reaction and the like.

As a method of graft polymerizing the constituents of the shell component, a method of adding monomers in one or more steps to the emulsified dispersion (latex) of the core component and polymerizing them by radical polymerization technique can be applied.

The emulsified dispersion (latex) of the core-shell type graft copolymer (A2) obtained by the above-mentioned production method can be separated and recovered by salting out for use.

The content of the core-shell type graft copolymer (A2) is preferably 0 to 10 parts by mass, and more preferably 3 to 7 parts by mass, when the total of the first acrylic component (B) and the second acrylic component (C) is 100 parts by mass. The content of the core-shell type graft copolymer (A2) is, specifically for example, 0, 1, 2, 3, 4, 5, 6, 7, 8, 9 or 10 parts by mass, and may be in the range between the two values exemplified herein. When the content is within this range, it is possible to suppress the decrease in heat cycle resistance and impart thixotropy. It should be noted that the content of the core-shell type graft copolymer (A2) means the total amount of the core-shell type graft copolymer (A2) used in combination when the core-shell type graft copolymer (A2) is used in combination.

### <(Meth)Acryloyl Modified Elastomer (A3)>

From the viewpoint of toughness, the two-agent type composition according to the present embodiment preferably contains the (meth)acryloyl modified elastomer (A3). The (meth)acryloyl modified elastomer (A3) means an elastomer having a (meth)acrylic acid monomer unit. Examples of the mode of imparting (meth)acrylic acid monomer unit include a mode in which a (meth)acryloyl group is present at the terminal position of the elastomer molecule, and a mode in which a (meth)acryloyl group is present in the molecular chain of the elastomer molecule. Preferably, the (meth)acryloyl modified elastomer has a (meth)acryloyl group at least at the terminal position of the elastomer molecule.

Examples of the (meth)acryloyl modified elastomer (A3) according to the present embodiment include terminally (meth)acryl modified NBR, terminally (meth)acryl modified polybutadiene, urethane (meth)acrylate, and terminally (meth)acryl modified silicone oil. Terminally (meth)acryl modified NBR is preferred from the viewpoint of toughness.

For example, as terminally (meth)acryl modified NBR, “HYPRO (registered trademark) 1300X33LC VTBNX” made by Huntsman Corporation can be mentioned as a commercially available product.

As for the (meth)acryloyl modified elastomer (A3) according to the present embodiment, one of these (meth)acryloyl modified elastomers (A3) may be used alone, or two or more of these may be used in combination.

The content of the (meth)acryloyl modified elastomer (A3) is preferably 1 to 40 parts by mass, and more preferably 10 to 30 parts by mass, when the total of the first acrylic component (B) and the second acrylic component (C) is 100 parts by mass. The content is, specifically for example, 1, 5, 10, 15, 20, 25, or 30 parts by mass, and may be in the range between the two values exemplified herein. When the content is within this range, toughness can be imparted. It should be noted that the content of the (meth)acryloyl modified elastomer means the total amount of the (meth)acryloyl modified elastomer (A3) used in combination when the (meth)acryloyl modified elastomer (A3) is used in combination.

### <First Acrylic Component (B)>

The two-agent type composition according to the present embodiment contains the first acrylic component (B). The first acrylic component (B) is a (meth)acrylate or (meth)acrylic acid, containing two or more hydroxyl groups bonded to a carbon atom in one molecule, or containing one or more functional groups of one or more kind of functional groups selected from the group consisting of an amide group, a cyclic amide group, a sulfoxide group, a ketone group, an aldehyde group, a sulfo group, a sulfino group, a phosphonic acid group, a sulfobetaine group, a carbobetaine group, and a phosphobetaine group in one molecule.

From the viewpoint of curing rate, the first acrylic component (B) according to the present embodiment preferably contains a (meth)acrylate or (meth)acrylic acid containing in one molecule two or more hydroxyl groups bonded to a carbon atom, or one or more functional groups of one or more kind of functional groups selected from the group consisting of a ketone group, an aldehyde group, a sulfoxide group, a sulfo group, a sulfino group, a sulfobetaine group, a carbobetaine group, a phosphonic group, and a phosphobetaine group, and more preferably a (meth)acrylate or (meth)acrylic acid containing two or more hydroxyl groups bonded to a carbon atom in one molecule.

Examples of the first acrylic component (B) according to the present embodiment include glycerin mono(meth)acrylate and maleic anhydride. Glycerin mono(meth)acrylate is preferred from the viewpoint of storage stability.

As for the first acrylic component (B) according to the present embodiment, one of these first acrylic components (B) may be used alone, or two or more of these may be used in combination.

From the viewpoint of curing rate, the content of the first acrylic component (B) according to the present embodiment is preferably 10 to 40 parts by mass, and more preferably 15 to 30 parts by mass, when the total of the first acrylic component (B) and the second acrylic component (C) is 100 parts by mass. The content is, specifically for example, 10, 15, 20, 25, 30, 35, or 40 parts by mass, and may be in the range between the two values exemplified herein. It should be noted that the content of the first acrylic component (B) means the total amount of the first acrylic component (B) used in combination when the first acrylic component (B) is used in combination.

<Second Acrylic Component (c)>

The two-agent type composition according to the present embodiment contains the second acrylic component (C). The second acrylic component (C) according to the present embodiment means the second acrylic component (C) that does not correspond to the above-mentioned first acrylic component (B).

Examples of the second acrylic component (C) according to the present embodiment include a (meth)acrylate or (meth)acrylic acid containing one hydroxyl group (C1); a (meth)acrylate or (meth)acrylic acid having a phenyl group (C2); a (meth)acrylate or (meth)acrylic acid having a unit of alkylene oxide or siloxane (C3); an acyclic multifunctional (meth)acrylate or (meth)acrylic acid (C4); and a phosphate compound having a (meth)acrylic group (C5). From the viewpoints of metal adhesion property, elastomer solubility, curing rate, hardness adjustment and the like, preferred is/are one or more kind selected from the group consisting of a (meth)acrylate or (meth)acrylic acid containing one hydroxyl group (C1), a (meth)acrylate or (meth)acrylic acid having a phenyl group (C2), a (meth)acrylate or (meth)acrylic acid having a unit of alkylene oxide or siloxane (C3).

As for the second acrylic component (C) according to the present embodiment, one of these second acrylic components (C) may be used alone, or two or more of these may be used in combination.

### <(Meth)Acrylate or (Meth)Acrylic Acid Containing One Hydroxyl Group (C1)>

Examples of the (meth)acrylate or (meth)acrylic acid containing one hydroxyl group (C1) according to the present embodiment include 2-hydroxyethyl (meth)acrylate, 3-hydroxypropyl (meth)acrylate, and 4-hydroxybutyl (meth)acrylate. From the viewpoint of metal adhesion property, 2-hydroxyethyl (meth)acrylate is preferred.

As for the (meth)acrylate or (meth)acrylic acid (C1) according to the present embodiment, one of these (meth)acrylates or (meth)acrylic acids (C1) may be used alone, or two or more of these may be used in combination.

### <(Meth)Acrylate or (Meth)Acrylic Acid Having Phenyl Group (C2)>

Examples of the (meth)acrylate or (meth)acrylic acid having a phenyl group (C2) according to the present embodiment include phenoxyethyl (meth)acrylate, phenoxydiethylene glycol (meth)acrylate, phenoxy-polyethylene glycol (meth)acrylate, 2-hydroxy-3-phenoxypropyl (meth)acrylate, neopentyl glycol-(meth)acrylic-benzoic acid ester (meth)acrylate, and benzyl (meth)acrylate. Phenoxyethyl (meth)acrylate is preferred from the viewpoint of elastomer solubility. As for the (meth)acrylate or (meth)acrylic acid (C2), one of these (meth)acrylates or (meth)acrylic acids (C2) may be used alone, or two or more of these may be used in combination.

### <(Meth)Acrylate or (Meth)Acrylic Acid Having Unit of Alkylene Oxide or Siloxane (C3)>

From the viewpoint of toughness, the (meth)acrylate or (meth)acrylic acid having a unit of alkylene oxide or siloxane (C3) according to the present embodiment has 4 to 15 units, preferably 6 to 13 units of alkylene oxide or siloxane in the molecule. When the units of alkylene oxide or siloxane are contained separately at two or more locations in the molecule, the total number of units of alkylene oxide or siloxane present at each location is 4 to 15, and preferably 6 to 13.

Further, the (meth)acrylate or (meth)acrylic acid having a unit of alkylene oxide or siloxane (C3) according to the present embodiment is preferably multifunctional from the viewpoint of toughness and curing rate.

Examples of such a (meth)acrylate having a unit of alkylene oxide or siloxane (C3) include bisphenol A alkylene oxide modified di(meth)acrylate, 2,2-bis(4-(meth)acryloxyphenyl)propane, 2,2-bis(4-(meth)acryloxyethoxyphenyl)propane, 2,2-bis(4-(meth)acryloxydiethoxyphenyl)propane, 2,2-bis(4-(meth)acryloxypropoxyphenyl) propane, 2,2-bis(4-(meth)acryloxytetraethoxyphenyl)propane, and 2,2-bis(4-(meth)acryloxypolyethoxyphenyl)propane. From the viewpoint of curing rate, bisphenol A alkylene oxide modified di(meth)acrylates are preferred. Among bisphenol A alkylene oxide modified di(meth)acrylates, bisphenol A EO (ethylene oxide) modified di(meth)acrylate is preferred. Among bisphenol A alkylene oxide modified di(meth)acrylates, a compound represented by the general formula (A) is preferred.

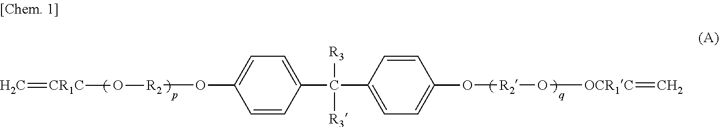

In the formula (A), R₁ and R₁′ each represent a hydrogen atom or a methyl group. R₁ and R₁′ may be identical or different. R₂ and R₂′ each represent an alkylene group. The alkylene group may have one hydroxyl group. R₂ and R₂′ may be identical or different. R₃ and R₃′ each represent a hydrogen atom or an alkyl group having 1 to 4 carbon atoms. R₃ and R₃′ may be identical or different. Further, p+q represents a number of 1 to 20, and p and q may be identical or different.

In the general formula (A), R₂ and R₂′ are preferably alkylene groups without a hydroxyl group from the viewpoint of storage stability.

Among these, the following are preferred from the viewpoint of high resin strength. R₁ and R₁′ are preferably methyl groups. R₂ and R₂′ are preferably alkylene groups having 1 to 12 carbon atoms, and more preferably ethylene groups. Preferably, the alkylene group does not have a hydroxyl group. R₃ and R₃′ are preferably methyl groups.

From the viewpoint of resin properties and combustion resistance of the cured product, p+q is a number of 1 to 20, preferably 5 to 15, and more preferably 10.

As for the (meth)acrylate or (meth)acrylic acid (C3), one of these (meth)acrylates or (meth)acrylic acids (C3) may be used alone, or two or more of these may be used in combination.

### <Acyclic Multifunctional (Meth)Acrylate or (Meth)Acrylic Acid (C4)>

Examples of the acyclic multifunctional (meth)acrylate or (meth)acrylic acid (C4) according to the present embodiment include trimethylolpropane tri(meth)acrylate, neopentyl glycol di(meth)acrylate, pentaerythritol tri(meth)acrylate, pentaerythritol tetra(meth)acrylate, and dipentaerythritol hexa(meth)acrylate. From the viewpoint of hardness adjustment, trimethylolpropane tri(meth)acrylate is preferred.

As for the (meth)acrylate or (meth)acrylic acid (C4) according to the present embodiment, one of these (meth)acrylates or (meth)acrylic acids (C4) may be used alone, or two or more of these may be used in combination.

### <Phosphate Compound Having (Meth)Acrylic Group (C5)>

Examples of the phosphate compound having a (meth)acrylic group include phosphate esters having a (meth)acrylic group. Examples of the phosphate ester having a (meth)acrylic group include (2-hydroxyethyl) methacrylic acid phosphate, (meth)acryloyloxyethyl acid phosphate, dibutyl 2-(meth)acryloyloxyethyl acid phosphate, dioctyl 2-(meth)acryloyloxyethyl phosphate, diphenyl 2-(meth)acryloyloxyethyl phosphate, (meth)acryloyloxyethyl polyethylene glycol acid phosphate, and (meth)acryloyloxyethyl acid phosphate monoethanolamine half salt.

One or two or more kind of these can be used.

### <Monofunctional (Meth)Acrylate or (Meth)Acrylic Acid in First Acrylic Component (B) and Second Acrylic Component (C)>

The two-agent type composition according to the present embodiment preferably contains a monofunctional (meth)acrylate or (meth)acrylic acid. The monofunctional (meth)acrylate or (meth)acrylic acid according to the present embodiment means a (meth)acrylate or (meth)acrylic acid containing one (meth)acrylate group or (meth)acrylic acid group in the molecule. The first acrylic component (B) may be contained as the monofunctional (meth)acrylate or (meth)acrylic acid, the second acrylic component (C) may be contained as the monofunctional (meth)acrylate or (meth)acrylic acid, and the first acrylic component (B) and the second acrylic component (C) may be contained as the monofunctional (meth)acrylate or (meth)acrylic acid. Preferably, at least the first acrylic component (B) is contained as the monofunctional (meth)acrylate or (meth)acrylic acid from the viewpoint of curing rate.

Examples of the monofunctional (meth)acrylate or (meth)acrylic acid according to the present embodiment include glycerin mono(meth)acrylate as the first acrylic component (B), and 2-hydroxyethyl (meth)acrylate, phenoxyethyl (meth)acrylate, 2-hydroxy-3-phenoxypropyl (meth)acrylate, 3-hydroxypropyl (meth)acrylate as the second acrylic component (C). From the viewpoint of curing rate, preferred is/are one or more kind selected from the group consisting of glycerin mono(meth)acrylate, 2-hydroxyethyl(meth)acrylate, phenoxyethyl(meth)acrylate, 3-hydroxypropyl(meth)acrylate.

As for the monofunctional (meth)acrylate or (meth)acrylic acid, one of these monofunctional (meth)acrylates or (meth)acrylic acids may be used alone, or two or more of these may be used in combination.

As for the two-agent type composition according to the present embodiment, from the viewpoint of curing rate, the content of the monofunctional (meth)acrylate or (meth)acrylic acid in the first acrylic component (B) and the second acrylic component (C) is preferably 70 to 100 parts by mass, and more preferably 75 to 90 parts by mass, when the total of the first acrylic component (B) and the second acrylic component (C) is 100 parts by mass. The content of the monofunctional (meth)acrylate or (meth)acrylic acid is, specifically for example, 70, 75, 80, 85, 90, 95, or 100 parts by mass, and may be in the range between the two values exemplified herein. It should be noted that the content of the monofunctional (meth)acrylate or (meth)acrylic acid means the total amount of the monofunctional (meth)acrylate or (meth)acrylic acid used in combination when the monofunctional (meth)acrylate or (meth)acrylic acid is used in combination.

### <Polymerization Initiator (D)>

The two-agent type composition according to the present embodiment contains a polymerization initiator (D). The polymerization initiator (D) according to the present embodiment has a role in curing the two-agent type composition.

Examples of the polymerization initiator (D) include cumene hydroperoxide, benzoyl peroxide, t-butyl peroxybenzoate, t-butyloxyacetate, t-butyl peroxyisobutyrate, and t-butyl peroxyphthalate. From the viewpoint of curability and storage stability, cumene hydroperoxide is preferred.

As for the polymerization initiator (D) according to the present embodiment, one of these polymerization initiators (D) may be used alone, or two or more of these may be used in combination.

As for the two-agent type composition according to the present embodiment, from the viewpoint of curability and storage stability, the content of the polymerization initiator (D) is preferably 1 to 10 parts by mass, and more preferably 3 to 7 parts by mass, when the total of the first acrylic component (B) and the second acrylic component (C) is 100 parts by mass. The content of the polymerization initiator (D) is, specifically for example, 1, 2, 3, 4, 5, 6, 7, 8, 9, or 10 parts by mass, and may be in the range between the two values exemplified herein. It should be noted that the content of polymerization initiator (D) means the total amount of the polymerization initiator (D) used in combination when the polymerization initiator (D) is used in combination.

### <Condensate of Amine and Aldehyde (E)>

The two-agent type composition according to the present embodiment contains a condensate of amine and aldehyde (E). The condensate of amine and an aldehyde (E) is a condensate of any amine (alkyl amine and aryl amine) and any aldehyde, and may include not only those with a single structure but also mixtures or compounds obtained as a result of condensation. Examples of the condensate of amine and aldehyde include amine complex mixtures obtained by condensing at least 1 mole, preferably 1.5 to 3 moles of aldehyde to 1 mole of amine at 40 to 70° C. in the presence of a carboxylic acid or inorganic acid. Propionic acid, phosphoric acid, or acetic acid is used as an example of the carboxylic acid or inorganic acid. Butylamine or aniline, and butyraldehyde are used as an example of the amine and aldehyde.

Examples of the condensate of amine and aldehyde (E) according to the present embodiment include reaction condensates of butylamine or aniline with butyraldehyde, and aldehydeaniline. The aldehydeaniline according to the present embodiment refers to a reaction condensate of aldehydes and anilines. More specifically, n-buthylaldehydeaniline and the like can be mentioned. From the viewpoint of curing rate, n-buthylaldehydeaniline is preferred.

As for the condensate of amine and aldehyde (E) according to the present embodiment, one of these condensates of an amine and an aldehyde (E) may be used alone, or two or more of these may be used in combination.

As for the two-agent type composition according to the present embodiment, from the viewpoint of curing rate, the content of the condensate of amine and aldehyde (E) is preferably 5 to 40 parts by mass, and more preferably 10 to 30 parts by mass, when the total of the third acrylic component (F), the condensate of amine and aldehyde (E), and the reducing agent (G) is 100 parts by mass. The content of the condensate of amine and aldehyde (E) is, specifically for example, 5, 10, 15, 20, 25, 30, 35, or 40 parts by mass, and may be in the range between the two values exemplified herein. It should be noted that, when the condensate of amine and aldehyde (E) is used in combination, the content of the condensate of amine and aldehyde (E) means the total amount of condensate of amine and aldehyde (E) used in combination as well as not only those with a single structure but also the mixture or compound obtained as a result of condensation for each of the condensates of an amine and an aldehyde (E) used in combination.

### <Third Acrylic Component (F)>

The two-agent type composition according to the present embodiment contains the third acrylic component (F) in the second agent. Examples of the third acrylic component (F) according to the present embodiment include those exemplified in the first acrylic component (B) and the second acrylic component (C) used in the first agent.

As for the third acrylic component (F) according to the present embodiment, one of these third acrylic components (F) may be used alone, or two or more of these may be used in combination. Further, the third acrylic component (F) according to the present embodiment may be the same as or different from the first acrylic component (B) and the second acrylic component (C) used in the first agent. From the viewpoint of low volatility and ease of application, one or more kind selected from the following group is/are preferred: phenoxyethyl (meth)acrylate, phenoxydiethylene glycol (meth)acrylate, phenoxypolyethylene glycol (meth)acrylate, 2-hydroxy-3-phenoxypropyl (meth)acrylate, neopentyl glycol-(meth)acrylic acid-benzoic acid ester (meth)acrylate, and benzyl (meth)acrylate.

### <Fluorine-Containing (Meth)Acrylate or Fluorine-Containing (Meth)Acrylic Acid (F1)>

From the viewpoint of lowering surface tension of liquid and improving wettability to an adherend, the two-agent type polymerizable composition according to the present embodiment preferably contains a fluorine-containing (meth)acrylate or fluorine-containing (meth)acrylic acid (F1) in the third acrylic component (F). The fluorine-containing (meth)acrylate or fluorine-containing (meth)acrylic acid means a (meth)acrylate or (meth)acrylic acid having one or more fluorine atom(s) in the molecule.

As the fluorine-containing (meth)acrylate (F1) according to the present embodiment, fluorine-containing (meth)acrylates containing an alkyl fluoride group are preferred. Among them, those containing difluoromethylene (—CF₂—) are preferred. Examples thereof include monofunctional (meth)acrylates such as 1H, 1H, 2H, 2H-tridecafluorooctyl (meth)acrylate, 2,2,2-trifluoroethyl (meth)acrylate, 2,2,3,3-tetrafluoropropyl (meth)acrylate, 1H,1H,5H-octafluoropentyl (meth)acrylate, 3,3,4,4,5,5,6,6,7,7,8,8,8-tridecafluorooctyl (meth)acrylate; and multifunctional (meth)acrylates such as 2,2,3,3,4,4,5,5,6,6,7,7,8,8,9,9-hexadecafluoro-1,10-decane di(meth)acrylate. From the viewpoint of wettability on the adherend and storage stability, 1H,1H,2H,2H-tridecafluorooctyl (meth)acrylate is most preferred.

As for the fluorine-containing (meth)acrylate or fluorine-containing (meth)acrylic acid (F1) according to the present embodiment, one of these fluorine-containing (meth)acrylates or fluorine-containing (meth)acrylic acids (F1) may be used alone, or two or more of these may be used in combination.

The addition of the fluorine-containing (meth)acrylate or fluorine-containing (meth)acrylic acid (F1) is expected to improve the wet-spreading property when the second agent is applied to the adherend, thereby improving the applicability.

As for the two-agent type composition according to the present embodiment, from the viewpoint of improving workability by lowering the surface tension of the adhesive liquid and improving the wettability of the adherend, the content of the fluorine-containing (meth)acrylate or fluorine-containing (meth)acrylic acid (F1) is preferably 0.001 to 3 parts by mass, and more preferably 0.5 to 2 parts by mass, when the total of the third acrylic components (F) is 100 parts by mass. The content of the fluorine-containing (meth)acrylate or fluorine-containing (meth)acrylic acid (F1) is, specifically for example, 0.001, 0.5, 1.0, 1.5, 2.0, or 3.0 parts by mass, and may be in the range between the two values exemplified herein. It should be noted that the amount of the fluorine-containing (meth)acrylate or fluorine-containing (meth)acrylic acid (F1) means the total amount of the fluorine-containing (meth)acrylate or fluorine-containing (meth)acrylic acid (F1) used in combination when the fluorine-containing (meth)acrylate or fluorine-containing (meth)acrylic acid (F1) is used in combination.

### <Reducing Agent (G)>

The two-agent type polymerizable composition according to the present embodiment contains the reducing agent (G). Examples of the reducing agent (G) according to the present embodiment include reducing agents that can react with the polymerization initiator (D) used in the first agent to generate radicals. Specifically, at least one kind selected from the group consisting of tertiary amines, thiourea derivatives, and transition metal salts is more preferred. Examples of the thiourea derivative include acetyl thiourea and ethyl thiourea. Examples of the transition metal salt include cobalt naphthenate, cobalt octylate, copper naphthenate, copper neodecanoate, and vanadyl acetylacetonate. From the viewpoint of curing rate, toughness and heat cycle resistance of the cured product of the adhesive, transition metal salts are preferred. As the transition metal salt, at least one selected from the group consisting of copper naphthenate and copper neodecanoate is preferred, and copper neodecanoate is more preferred. As for the reducing agent (G) according to the present embodiment, one of these reducing agents (G) may be used alone, or two or more of these may be used in combination.

As for the two-agent type composition according to the present embodiment, from the viewpoint of curing rate, the content of the reducing agent (G) is preferably 0.01 to 5 parts by mass, and more preferably 0.1 to 1 parts by mass, when the total of the third acrylic component (F), the condensate of amine and aldehyde (E), and the reducing agent (D) is 100 parts by mass. The content of the reducing agent (G) is, specifically for example, 0.01, 0.1, 0.2, 0.3, 0.4, 0.5, 1.0, 2.0, 3.0, 4.0, or 5.0 parts by mass, and may be in the range between the two values exemplified herein. It should be noted that the content of the reducing agent (G) means the total amount of the reducing agent (G) used in combination when the reducing agent (G) is used in combination.

### <Stabilizer (H)>

It is desirable that the two-agent type polymerizable composition according to the present embodiment further contain a stabilizer (H) in the second agent. By further containing the stabilizer (H) in the second agent, it is possible to prevent the viscosity of the second agent from increasing during storage. This is thought to be because, during storage, the stabilizer (H) prevents radicals from being generated by the condensate of amine and aldehyde (E) that facilitates the redox reaction between the reducing agent (D) and oxygen, and prevents the third acrylic component (F) from being polymerized to increase the viscosity.

As for the two-agent type composition according to the present embodiment, from the viewpoint of storage stability and curing rate, the content of the stabilizer (H) is preferably 0.001 to 0.5 parts by mass when the total of the condensate of amine and aldehyde (E), the third acrylic component (F), and the reducing agent (G) is 100 parts by mass. The storage stability is improved when the content is 0.001 parts by mass or more, and the curing rate is improved when the content is 0.5 parts by mass or less. From the viewpoint of storage stability and curing rate, the content of the stabilizer (H) is preferably 0.05 to 0.4 parts by mass, and more preferably 0.1 to 0.3 parts by mass. It is, specifically for example, 0.001, 0.01, 0.05, 0.1, 0.2, 0.3, 0.4, or 0.5 parts by mass, and may be in the range between the two values exemplified herein. It should be noted that the content of the stabilizer (H) means the total amount of the stabilizer (H) used in combination when the stabilizer (H) is used in combination.

The stabilizer (H) is not particularly limited as long as it is a known stabilizer, inhibitor, or antioxidant, and examples thereof include quinone-based stabilizers such as methylhydroquinone, hydroquinone, 2,2-methylene-bis(4-methyl-6-tertiary-butylphenol), catechol, hydroquinone monomethyl ether, monotertiary-butylhydroquinone, 2,5-ditertiary butyl hydroquinone, p-benzoquinone, 2,5-diphenyl-p-benzoquinone, and 2,5-ditertiary-butyl-p-benzoquinone; azine-based stabilizers such as phenothiazines; hindered phenol-based antioxidants such as citric acid, picric acid, tertiary-butyl catechol, 4-methoxyphenol, 2-butyl-4-hydroxyanisole, 2,6-ditertiary butyl-p-cresol, ammonium salt of N-nitroso-N-phenylhydroxylamine, tetrakis[methylene-3(3′5′di-t-butyl-4′-hydroxyphenyl)propionate]met hane, 3,9-bis[2-[3-(3-tert-butyl-4-hydroxy-5-methylphenyl)propionyloxy]-1,1-dimethylethyl]-2,4,8,10-tetraoxaspiro[5.5]undecane, 2-[1-(2-hydroxy-3,5-di-tert-pentylphenyl)ethyl]-4,6-di-tert-pentylp henyl (meth)acrylate, 2,2′-thiodiethyl bis[3-(3,5-di-tert-butyl-4-hydroxyphenyl)propionate, n-ocladecyl-3(3′,5′-di-t-butyl-4′-hydroxyphenyl)propionate, N,N′-hexamethylenebis[3-(3,5-di-tert-butyl-4-hydroxyphenyl)propanam ide, octyl 3-(4-hydroxy-3,5-diisopropylphenyl)propionate, 2,4,6-tris(3′,5′-di-tert-butyl-4′-hydroxybenzyl)mesitylene, 2,4-bis(dodecylthiomethyl)-6-methylphenol, calcium bis[3,5-di(tert-butyl)-4-hydroxybenzyl(ethoxy)phosphinate], 2,4-bis(octylthiomethyl)-6-methylphenol, bis[3-(3-tert-butyl-4-hydroxy-5-methylphenyl)propionic acid][ethylenebis(oxyethylene)], 1,6-hexanediol bis[3-(3,5-di-tert-butyl-4-hydroxyphenyl)propionate], tris(3,5-di-t-butyl-4-hydroxybenzyl)isocyanate, bis[4-(1,1,3,3-tetramethylbutyl)phenyl]amine, 4-[[4,6-bis(octylthio)-1,3,5-triazin-2-yl]amino]-2,6-di-tert-butylp henol, 3,5-di-tert-butyl-4-hydroxybenzylphosphonic acid diethyl, and 1,3,5-tris[4-(1,1-dimethylethyl)-3-hydroxy-2,6 dimethylphenyl]methyl]-1,3,5-triazine-2,4,6(1H,3H,5H)-trione; and stable radical type compounds having a stable radical such as 1-oxyl-2,2,6,6-tetramethylpiperidine, 4-hydroxy-2,2,6,6-tetramethylpiperidine 1-oxyl, and 4-methacryloyloxy-2,2,6,6-tetramethylpiperidine 1-oxyl. The stable radical type compounds are particularly preferred from the viewpoint of storage stability. At least one kind selected from the group consisting of 1-oxyl-2,2,6,6-tetramethylpiperidine, 4-hydroxy-2,2,6,6-tetramethylpiperidine 1-oxyl and 4-methacryloyloxy-2,2,6,6-tetramethylpiperidine 1-oxyl is preferred as the stable radical type compound. The stable radical type compounds having a nitroxide radical as a stable radical are further preferred. Specifically, 4-hydroxy-2,2,6,6-tetramethylpiperidine 1-oxyl is most preferred. One of the stabilizers (H) may be used alone, or two or more of the stabilizers (H) may be used in combination.

### <Viscosity of First Agent>

As for the two-agent type composition according to the present embodiment, from the viewpoint of workability (adhesive applicability), the viscosity of the first agent is preferably 1,000 to 100,000 mPa·s, and more preferably 1,000 to 50,000 mPa·s.

Here, the viscosity of the first agent refers to the viscosity of the composition containing the elastomer (A), the first acrylic component (B), the second acrylic component (C), and the polymerization initiator (D).

The viscosity of the first agent according to the present embodiment is measured at 25° C. in accordance with JISK7117-1.

### <Viscosity of Second Agent>

As for the two-agent type composition according to the present embodiment, from the viewpoint of improving applicability to the adherend, the viscosity of the second agent is 1 to 1,000 mPa·s, and more preferably 5 to 100 mPa·s.

The viscosity of the second agent according to the present embodiment is measured at 25° C. in accordance with JISK7117-1.

### <Composition Distribution of First Agent and Second Agent>

The two-agent type composition according to the present embodiment preferably has the composition distribution of the first agent: the second agent=50 to 98 parts by mass: 2 to 50 parts by mass, and more preferably has the composition distribution of the first agent: the second agent=80 to 95:5 to 20 parts by mass, when the total of the first agent and the second agent is 100 parts by mass.

Further, as for the two-agent type composition according to the present embodiment, from the viewpoint of heat cycle resistance, the amount of the elastomer (A) contained in the first agent is preferably 55 to 100 parts by mass, more preferably 80 to 100 parts by mass, and even more preferably 95 to 100 parts by mass, when the total amount of the elastomer (A) contained in the first agent and the elastomer (A) contained in the second agent is 100 parts by mass. In one embodiment, it is preferable that the elastomer (A) be contained substantially only in the first agent.

### <Adhesive>

The two-agent type composition according to the present embodiment can be made into an adhesive by adding additives such as a polymerization inhibitor, a stabilizer, an antioxidant, and a UV absorber as needed.

### <Joined Body>

A joined body can be obtained by applying the composition according to the present embodiment to an adherend and adhering the adherend.

The joined body is obtained, for example, by applying the first agent to one of the adherend surfaces or adherends, applying the second agent to the other adherend surface or adherend, and then joining these two adherend surfaces or adherends by putting them together.

Examples of the material of the adherend in the above-mentioned embodiment includes iron and a plated surface, but is not limited thereto.

Since the above-mentioned adhesive composition shows the excellent adhesion property, especially to iron and a plated surface, it can be suitably used for ferrite magnets, plated products and the like.

According to the composition according to the present embodiment, it is possible to join adherends in an extremely short time, thus achieving a fast-curing property. Further, the composition according to the present embodiment is also excellent in heat cycle resistance.

Therefore, the composition according to the present embodiment is suitable as an adhesive in the manufacturing of products that require the fast-curing property and are expected to be used in environments including low to high temperatures, such as−40 to 100° C. Examples of such a product include speakers, motors, and power transformers.

### EXAMPLES

Hereinafter, the present invention will be described in more detail with reference to Examples. These are merely examples, and the present invention is not limited thereto.

### <Raw Material Used>

### [Elastomer (A)]

Liquid NBR (product name: 1300X33LC VTBNX, made by Huntsman Corporation, terminally methacryl modified NBR, nitrile content: 18 parts by mass in 100 parts by mass of NBR, viscosity: 250,000 mPa·s)
Solid NBR (product name: N-230SV, made by JSR Corporation, nitrile content: 30 to 35 parts by mass in 100 parts by mass of NBR)
Butadiene rubber (product name: BRO1, made by JSR Corporation)
Core-shell type graft copolymer (product name: BL-20, made by Denka Company Limited, MBAS polymer, containing 15 parts by mass of methyl methacrylate, 47 parts by mass of butadiene and 38 parts by mass of other vinyl-based monomer in 100 parts by mass of the total of methyl methacrylate, butadiene and other vinyl-based monomer)

### [First Acrylic Component (B)]

Glycerin monomethacrylate (product name: Blemmer GLM, made by NOF CORPORATION)

### [Second Acrylic Component (C)]

2-hydroxyethyl methacrylate (product name: 2HEMA, made by Mitsubishi Gas Chemical Company, Inc.)
Phenoxyethyl methacrylate (product name: M141, made by Miwon Specialty Chemical)
Bisphenol A EO modified dimethacrylate (product name: BPE-500, made by SHIN-NAKAMURA CHEMICAL Co., Ltd., 2,2-bis(4-(methacryloxy polyethoxy)phenyl) propane, in the above general formula (A), R₁ and R₁′ each represent a methyl group, R₁ and R₁′ each represent an ethylene group, R₁ and R₁′ each represent a methyl group, p+q=10)
Methacrylic acid (product name: GE-110, made by Mitsubishi Gas Chemical Company, Inc.)
(2-hydroxyethyl) methacrylate acid phosphate (product name: JPA-514, made by Johoku Chemical Co., Ltd.)

### [Polymerization Initiator (D)]

Cumene hydroperoxide (product name: PH-80, made by NOF CORPORATION)

### [Condensate of Amine and Aldehyde (E)]

n-buthylaldehydeaniline (product name: NX-8, made by OUCHI SHINKO CHEMICAL INDUSTRIAL CO., LTD.)

### [Third Acrylic Component (F)]

Phenoxyethyl methacrylate (product name: PO, Kyoeisha Chemical Co., Ltd.)
1H,1H,2H,2H-tridecafluorooctyl acrylate (product name: Viscoat 13F, made by OSAKA ORGANIC CHEMICAL INDUSTRY LTD.)

### [Reducing Agent (G)]

Copper neodecanoate (product name: copper neodecanoate, made by Nihon Kagaku Sangyo Co., Ltd.) [Stabilizer (H)]
4-Hydroxy-2,2,6,6-tetramethylpiperidine-1-oxyl (general name: Tempol, made by Tokyo Chemical Industry Co., Ltd.)
4-Methoxyphenol (product name: MQ-F, made by Kawaguchi Chemical Industry Co., Ltd.)
p-Benzoquinone (product name: PBQ, made by SEIKO CHEMICAL Co., Ltd.)

### <Examples 1 to 20 and Comparative Examples 1 to 6>

The elastomer (A), the first acrylic component (B), the second acrylic component (C), and the polymerization initiator (D) were mixed in the proportions shown in Table 1 to prepare the first agent. The condensate of amine and aldehyde (E), the third acrylic component (F), the reducing agent (G), and the stabilizer (H) were mixed in the proportions shown in Table 1 to prepare the second agent. The adhesive consisting of the first agent and the second agent were prepared. The first agent and the second agent were mixed at a mass ratio of 9:1.

The fixture time of the adhesive obtained using the adhesive consisting of the first agent and the second agent in which the above-mentioned additives are added and the impact resistance of the cured product after heat cycle exposure were measured by the following methods.

### <Measurement of Fixture Time>

The test pieces for tensile shear adhesive strength measurement were prepared in accordance with JIS K6850.

The first agent in which additives were added was applied to one of the test pieces for tensile shear adhesive strength measurement, and the second agent was applied to the other test piece. The application surfaces of each adherend were adhered by putting them together.

Using the test piece 20 s after adhesion, the tensile shear adhesive strength was measured with a push-pull gauge.

The tensile shear adhesive strength was evaluated in accordance with the following evaluation criteria and used as an index of the fast-curing property.
A: The tensile shear adhesive strength is 0.05 MPa or more
B: The tensile shear adhesive strength is 0.03 MPa or more and less than 0.05 MPa
C: The tensile shear adhesive strength is less than 0.03 MPa
   <Impact Resistance of Cured Product after Heat Cycle Exposure>

Ferrite magnets/iron plates were adhered as the adherend by the above-mentioned application method, and a test piece for heat cycle exposure was prepared.

The test piece for heat cycle exposure was repeatedly exposed to 50 cycles of heat cycling, in which the temperature was increased from −40° C. to 110° C. at 2° C./min and then decreased from 110° C. to −40° C. at 2° C./min for cooling.

The test piece after exposure was dropped from a height of 1 m to perform an impact resistance test.

The impact resistance of the cured product after heat cycle exposure was evaluated in accordance with the following evaluation criteria and used as an index of heat cycle resistance.
A: The test piece did not peel off after performing impact resistance tests 30 times
B: The test piece peeled off after performing impact resistance tests 21 to 29 times
C: The test piece peeled off after performing impact resistance tests 11 to 20 times
D: The test piece peeled off after performing impact resistance tests 10 times or less

### <Viscosity of First Agent>

The viscosity of the first agent was measured at 25° C. in accordance with JIS K7117-1.

### <Viscosity of Second Agent>

The viscosity of the second agent was measured at 25° C. in accordance with JIS K7117-1.

### <Storage Stability (Second Agent)>

Into a 20 ml vial (made of glass), 10 g of the second agent was weighed, and after 14 days of exposure under an atmosphere at 60° C., the viscosity was measured at 25° C. in accordance with JIS K7117-1. The viscosity increasing rate was calculated using the following formula.

Viscosity increasing rate (%)=(viscosity after 14 days of exposure/viscosity before 14 days of exposure)×100

The above results are shown in Tables 1 to 4. In Tables, the content of each component represents parts by mass. The nitrile content of NBR is the content (parts by mass) of the (meth)acrylonitrile monomer unit in 100 parts by mass of NBR. Further, the “content of B in A” means the content of B in 100 parts by mass of A.

TABLE 1

| | | | 1 | 2 | 3 | 4 | 5 | 6 | 7 |
|---|---|---|---|---|---|---|---|---|---|
| First | Elastomer (A) | Liquid NBR (Nitrile Content: 18) | 20.00 | 20.00 | 20.00 | 20.00 | 20.00 | 10.00 | 30.00 |
| Agent | | Solid NBR (Nitrile Content: 30 to 35) | 12.60 | 14.00 | 10.50 | 12.60 | 12.60 | 12.60 | 12.60 |
| | | Butadiene Rubber | 0.00 | 0.00 | 0.00 | 0.00 | 0.00 | 0.00 | 0.00 |
| | | MBAS Polymer | 5.40 | 6.00 | 4.50 | 5.40 | 5.40 | 5.40 | 5.40 |
| | First Acrylic | Glycerin Monomethacrylate | 22.55 | 22.00 | 23.38 | 25.01 | 15.01 | 22.55 | 22.55 |
| | Component (B) | | | | | | | | |
| | Second Acrylic | 2-Hydroxyethyl Methacrylate | 24.60 | 24.00 | 25.50 | 24.60 | 24.60 | 24.60 | 24.60 |
| | Component (C) | Phenoxyethyl Methacrylate | 24.60 | 24.00 | 25.50 | 24.60 | 24.60 | 24.60 | 24.60 |
| | | Bisphenol A EO modified | 10.25 | 10.00 | 10.63 | 7.79 | 17.79 | 10.25 | 10.25 |
| | | dimethacrylate (p + q = 10) | | | | | | | |
| | | Methacrylic Acid | 0.00 | 0.00 | 0.00 | 0.00 | 0.00 | 0.00 | 0.00 |
| | | (2-Hydroxyethyl) Methacrylate Acid | 0.00 | 0.00 | 0.00 | 0.00 | 0.00 | 0.00 | 0.00 |
| | | Phosphate | | | | | | | |
| | Polymerization | Cumene Hydroperoxide | 5.00 | 5.00 | 5.00 | 5.00 | 5.00 | 5.00 | 5.00 |
| | Initiator (D) | | | | | | | | |
| | Content of (B) in (B) + (C) | | 27.50 | 27.50 | 27.50 | 30.50 | 18.30 | 27.50 | 27.50 |
| | Content of Monofunctional (Meth)acrylate in (B) + (C) | | 87.50 | 87.50 | 87.50 | 90.50 | 78.30 | 87.50 | 87.50 |
| | Content of (A) to (B) + (C) | | 46.34 | 50.00 | 41.18 | 46.34 | 46.34 | 34.15 | 58.54 |
| | Content of Core-shell Type Elastomer to (B) + (C) | | 6.59 | 7.50 | 5.29 | 6.59 | 6.59 | 6.59 | 6.59 |
| | Nitrile Content in (A) | | 0.215 | 0.217 | 0.212 | 0.215 | 0.215 | 0.228 | 0.208 |
| | Content of Liquid NBR to (B) + (C) | | 24.39 | 25.00 | 23.53 | 24.39 | 24.39 | 12.20 | 36.59 |
| | Content of Liquid NBR in (A) | | 52.63 | 50.00 | 57.14 | 52.63 | 52.63 | 35.71 | 62.50 |
| Second | Condensate of Amine | n-Buthylaldehydeaniline | 17.50 | 17.50 | 17.50 | 17.50 | 17.50 | 17.50 | 17.50 |
| Agent | and Aldehyde (E) | | | | | | | | |
| | Third Acrylic | Phenoxyethyl Methacrylate | 90.00 | 90.00 | 90.00 | 90.00 | 90.00 | 90.00 | 90.00 |
| | Component (F) | 1H,1H,2H,2H-Tridecafluorooctyl | 0.00 | 0.00 | 0.00 | 0.00 | 0.00 | 0.00 | 0.00 |
| | | Acrylate | | | | | | | |
| | Reducing Agent (G) | Copper Neodecanoate | 0.50 | 0.50 | 0.50 | 0.50 | 0.50 | 0.50 | 0.50 |
| | Stabilizer (H) | 4-Hydroxy-2,2,6,6- | 0.00 | 0.00 | 0.00 | 0.00 | 0.00 | 0.00 | 0.00 |
| | | tetramethylpiperidine-1-oxyl | | | | | | | |
| | | 4-Methoxyphenol | 0.00 | 0.00 | 0.00 | 0.00 | 0.00 | 0.00 | 0.00 |
| | | p-Benzoquinone | 0.00 | 0.00 | 0.00 | 0.00 | 0.00 | 0.00 | 0.00 |
| Physical Property Evaluation | | Viscosity of First Agent (mPa · s) | 35000 | 50000 | 25000 | 30000 | 30000 | 35000 | 40000 |
| | | Viscosity of Second Agent (mPa · s) | 10 | 10 | 10 | 10 | 10 | 10 | 10 |
| | | Storage Stability (Viscosity Increasing | 740 | 800 | 650 | 590 | 1100 | 970 | 640 |
| | | Rate of Second Agent/%) | | | | | | | |
| | | Fixture Time | A | A | A | A | A | A | A |
| | | Heat Cycle Resistance | A | A | A | A | A | A | A |

TABLE 2

| | | | 8 | 9 | 10 | 11 | 12 | 13 | 14 |
|---|---|---|---|---|---|---|---|---|---|
| First | Elastomer (A) | Liquid NBR (Nitrile Content: 18) | 20.00 | 20.00 | 20.00 | 20.00 | 0.00 | 20.00 | 20.00 |
| Agent | | Solid NBR (Nitrile Content: 30 to 35) | 9.10 | 17.50 | 12.60 | 12.60 | 0.00 | 12.60 | 12.60 |
| | | Butadiene Rubber | 0.00 | 0.00 | 0.00 | 0.00 | 32.60 | 0.00 | 0.00 |
| | | MBAS Polymer | 3.90 | 2.50 | 5.40 | 5.40 | 5.40 | 5.40 | 5.40 |
| | First Acrylic | Glycerin Monomethacrylate | 23.93 | 22.00 | 10.00 | 22.55 | 22.55 | 22.55 | 22.55 |
| | Component (B) | | | | | | | | |
| | Second Acrylic | 2-Hydroxyethyl Methacrylate | 26.10 | 24.00 | 24.60 | 24.60 | 24.60 | 0.00 | 24.60 |
| | Component (C) | Phenoxyethyl Methacrylate | 26.10 | 24.00 | 24.60 | 24.60 | 24.60 | 24.60 | 24.60 |
| | | Bisphenol A EO modified | 10.88 | 10.00 | 10.25 | 10.25 | 10.25 | 10.25 | 0.00 |
| | | dimethacrylate (p + q = 10) | | | | | | | |
| | | Methacrylic Acid | 0.00 | 0.00 | 0.00 | 0.00 | 0.00 | 0.00 | 0.00 |
| | | (2-Hydroxyethyl) Methacrylate Acid | 0.00 | 0.00 | 0.00 | 0.00 | 0.00 | 0.00 | 0.00 |
| | | Phosphate | | | | | | | |
| | Polymerization | Cumene Hydroperoxide | 5.00 | 5.00 | 5.00 | 5.00 | 5.00 | 5.00 | 5.00 |
| | Initiator (D) | | | | | | | | |
| | Content of (B) in (B) + (C) | | 27.50 | 27.50 | 14.40 | 27.50 | 27.50 | 39.29 | 31.43 |
| | Content of Monofunctional (Meth)acrylate in (B) + (C) | | 87.50 | 87.50 | 85.24 | 87.50 | 87.50 | 82.14 | 100.00 |
| | Content of (A) to (B) + (C) | | 37.93 | 50.00 | 54.71 | 46.34 | 46.34 | 66.20 | 52.96 |
| | Content of Core-shell Type Elastomer to (B) + (C) | | 4.48 | 3.13 | 7.77 | 6.59 | 6.59 | 9.41 | 7.53 |
| | Nitrile Content in (A) | | 0.209 | 0.245 | 0.215 | 0.215 | 0.004 | 0.215 | 0.215 |
| | Content of Liquid NBR to (B) + (C) | | 22.99 | 25.00 | 28.80 | 24.39 | 0.00 | 34.84 | 27.87 |
| | Content of Liquid NBR in (A) | | 60.61 | 50.00 | 52.63 | 52.63 | 0.00 | 52.63 | 52.63 |
| Second | Condensate of Amine | n-Buthylaldehydeaniline | 17.50 | 17.50 | 17.50 | 17.50 | 17.50 | 17.50 | 17.50 |
| Agent | and Aldehyde (E) | | | | | | | | |
| | Third Acrylic | Phenoxyethyl Methacrylate | 90.00 | 90.00 | 90.00 | 90.00 | 90.00 | 90.00 | 90.00 |
| | Component (F) | 1H,1H,2H,2H-Tridecafluorooctyl | 0.00 | 0.00 | 0.00 | 1.00 | 0.00 | 0.00 | 0.00 |
| | | Acrylate | | | | | | | |
| | Reducing Agent (G) | Copper Neodecanoate | 0.50 | 0.50 | 0.50 | 0.50 | 0.50 | 0.50 | 0.50 |
| | Stabilizer (H) | 4-Hydroxy-2,2,6,6- | 0.00 | 0.00 | 0.00 | 0.00 | 0.00 | 0.00 | 0.00 |
| | | tetramethylpiperidine-1-oxyl | | | | | | | |
| | | 4-Methoxyphenol | 0.00 | 0.00 | 0.00 | 0.00 | 0.00 | 0.00 | 0.00 |
| | | p-Benzoquinone | 0.00 | 0.00 | 0.00 | 0.00 | 0.00 | 0.00 | 0.00 |
| Physical Property Evaluation | | Viscosity of First Agent (mPa · s) | 15000 | 60000 | 40000 | 35000 | 120000 | 60000 | 35000 |
| | | Viscosity of Second Agent (mPa · s) | 10 | 10 | 10 | 10 | 10 | 10 | 10 |
| | | Storage Stability (Viscosity | 990 | 1010 | 1120 | 820 | 950 | 1500 | 1430 |
| | | Increasing Rate of Second Agent/%) | | | | | | | |
| | | Fixture Time | A | A | B | A | A | B | B |
| | | Heat Cycle Resistance | B | A | A | A | A | A | A |

TABLE 3

| | | | 15 | 16 | 17 | 18 | 19 | 20 |
|---|---|---|---|---|---|---|---|---|
| First | Elastomer (A) | Liquid NBR (Nitrile Content: 18) | 20.00 | 0.00 | 20.00 | 20.00 | 20.00 | 20.00 |
| Agent | | Solid NBR (Nitrile Content: 30 to 35) | 20.00 | 12.60 | 4.60 | 12.60 | 12.60 | 12.60 |
| | | Butadiene Rubber | 0.00 | 0.00 | 0.00 | 0.00 | 0.00 | 0.00 |
| | | MBAS Polymer | 0.00 | 5.40 | 13.40 | 5.40 | 5.40 | 5.40 |
| | First Acrylic | Glycerin Monomethacrylate | 22.00 | 22.55 | 22.55 | 22.55 | 22.55 | 22.55 |
| | Component (B) | | | | | | | |
| | Second Acrylic | 2-Hydroxyethyl Methacrylate | 24.00 | 24.60 | 0.00 | 24.60 | 24.60 | 24.60 |
| | Component (C) | Phenoxyethyl Methacrylate | 24.00 | 24.60 | 0.00 | 24.60 | 24.60 | 24.60 |
| | | Bisphenol A EO modified | 10.00 | 10.25 | 24.60 | 10.25 | 10.25 | 10.25 |
| | | dimethacrylate (p + q = 10) | | | | | | |
| | | Methacrylic Acid | 0.00 | 0.00 | 24.60 | 0.00 | 0.00 | 0.00 |
| | | (2-Hydroxyethyl) Methacrylate Acid | 0.00 | 0.00 | 10.25 | 0.00 | 0.00 | 0.00 |
| | | Phosphate | | | | | | |
| | Polymerization | Cumene Hydroperoxide | 5.00 | 5.00 | 5.00 | 5.00 | 5.00 | 5.00 |
| | Initiator (D) | | | | | | | |
| | Content of (B) in (B) + (C) | | 27.50 | 27.50 | 27.50 | 27.50 | 27.50 | 27.50 |
| | Content of Monofunctional (Meth)acrylate in (B) + (C) | | 87.50 | 87.50 | 87.50 | 87.50 | 87.50 | 87.50 |
| | Content of (A) to (B) + (C) | | 50.00 | 21.95 | 46.34 | 46.34 | 46.34 | 46.34 |
| | Content of Core-shell Type Elastomer to (B) + (C) | | 0.00 | 6.59 | 16.34 | 6.59 | 6.59 | 6.59 |
| | Nitrile Content in (A) | | 0.265 | 0.254 | 0.148 | 0.215 | 0.215 | 0.215 |
| | Content of Liquid NBR to (B) + (C) | | 25.00 | 0.00 | 24.39 | 24.39 | 24.39 | 24.39 |
| | Content of Liquid NBR in (A) | | 50.00 | 0.00 | 52.63 | 52.63 | 52.63 | 52.63 |
| Second | Condensate of Amine | n-Buthylaldehydeaniline | 17.50 | 17.50 | 17.50 | 17.50 | 17.50 | 17.50 |
| Agent | and Aldehyde (E) | | | | | | | |
| | Third Acrylic | Phenoxyethyl Methacrylate | 90.00 | 90.00 | 90.00 | 90.00 | 90.00 | 90.00 |
| | Component (F) | 1H,1H,2H,2H-Tridecafluorooctyl | 0.00 | 0.00 | 0.00 | 0.00 | 0.00 | 0.00 |
| | | Acrylate | | | | | | |
| | Reducing Agent (G) | Copper Neodecanoate | 0.50 | 0.50 | 0.50 | 0.50 | 0.50 | 0.50 |
| | Stabilizer (H) | 4-Hydroxy-2,2,6,6- | 0.00 | 0.00 | 0.00 | 0.20 | 0.00 | 0.00 |
| | | tetramethylpiperidine-1-oxyl | | | | | | |
| | | 4-Methoxyphenol | 0.00 | 0.00 | 0.00 | 0.00 | 0.20 | 0.00 |
| | | p-Benzoquinone | 0.00 | 0.00 | 0.00 | 0.00 | 0.00 | 0.20 |
| Physical Property Evaluation | | Viscosity of First Agent (mPa · s) | 70000 | 45000 | 15000 | 35000 | 35000 | 35000 |
| | | Viscosity of Second Agent (mPa · s) | 10 | 10 | 10 | 10 | 10 | 10 |
| | | Storage Stability (Viscosity | 880 | 770 | 1040 | 0 | 270 | 47 |
| | | Increasing Rate of Second Agent/%) | | | | | | |
| | | Fixture Time | A | A | A | A | B | B |
| | | Heat Cycle Resistance | A | C | C | A | A | A |

TABLE 4

| | | | 1 | 2 | 3 | 4 | 5 | 6 |
|---|---|---|---|---|---|---|---|---|
| First | Elastomer (A) | Liquid NBR (Nitrile Content: 18) | 20.00 | 20.00 | 0.00 | 20.00 | 20.00 | 20.00 |
| Agent | | Solid NBR (Nitrile Content: 30 to 35) | 12.60 | 12.60 | 0.00 | 12.60 | 12.60 | 12.60 |
| | | Butadiene Rubber | 0.00 | 0.00 | 0.00 | 0.00 | 0.00 | 0.00 |
| | | MBAS Polymer | 5.40 | 5.40 | 0.00 | 5.40 | 5.40 | 5.40 |
| | First Acrylic | Glycerin Monomethacrylate | 0.00 | 62.00 | 28.00 | 22.55 | 22.55 | 22.55 |
| | Component (B) | | | | | | | |
| | Second Acrylic | 2-Hydroxyethyl Methacrylate | 24.60 | 0.00 | 30.00 | 24.60 | 24.60 | 24.60 |
| | Component (C) | Phenoxyethyl Methacrylate | 24.60 | 0.00 | 30.00 | 24.60 | 24.60 | 24.60 |
| | | Bisphenol A EO modified | 10.25 | 0.00 | 13.00 | 10.25 | 10.25 | 10.25 |
| | | dimethacrylate (p + q = 10) | | | | | | |
| | | Methacrylic Acid | 0.00 | 0.00 | 0.00 | 0.00 | 0.00 | 0.00 |
| | | (2-Hydroxyethyl) Methacrylate Acid | 0.00 | 0.00 | 0.00 | 0.00 | 0.00 | 0.00 |
| | | Phosphate | | | | | | |
| | Polymerization | Cumene Hydroperoxide | 5.00 | 5.00 | 5.00 | 0.00 | 5.00 | 5.00 |
| | Initiator (D) | | | | | | | |
| | Content of (B) in (B) + (C) | | 0.00 | 100.00 | 27.72 | 27.50 | 27.50 | 27.50 |
| | Content of Monofunctional (Meth)acrylate in (B) + (C) | | 82.76 | 100.00 | 87.13 | 87.50 | 87.50 | 87.50 |
| | Content of (A) to (B) + (C) | | 63.92 | 61.29 | 0.00 | 46.34 | 46.34 | 46.34 |
| | Content of Core-shell Type Elastomer to (B) + (C) | | 9.08 | 8.71 | 0.00 | 6.59 | 6.59 | 6.59 |
| | Nitrile Content in (A) | | 0.215 | 0.215 | 0.000 | 0.215 | 0.215 | 0.215 |
| | Content of Liquid NBR to (B) + (C) | | 33.64 | 32.26 | 0.00 | 24.39 | 24.39 | 24.39 |
| | Content of Liquid NBR in (A) | | 52.63 | 52.63 | 0.00 | 52.63 | 52.63 | 52.63 |
| Second | Condensate of Amine | n-Buthylaldehydeaniline | 17.50 | 17.50 | 17.50 | 17.50 | 0.00 | 17.50 |
| Agent | and Aldehyde (E) | | | | | | | |
| | Third Acrylic | Phenoxyethyl Methacrylate | 90.00 | 90.00 | 90.00 | 90.00 | 90.00 | 0.00 |
| | Component (F) | 1H,1H,2H,2H-Tridecafluorooctyl | 0.00 | 0.00 | 0.00 | 0.00 | 0.00 | 0.00 |
| | | Acrylate | | | | | | |
| | Reducing Agent (G) | Copper Neodecanoate | 0.50 | 0.50 | 0.50 | 0.50 | 0.50 | 0.50 |
| | Stabilizer (H) | 4-Hydroxy-2,2,6,6- | 0.00 | 0.00 | 0.00 | 0.00 | 0.00 | 0.00 |
| | | tetramethylpiperidine-1-oxyl | | | | | | |
| | | 4-Methoxyphenol | 0.00 | 0.00 | 0.00 | 0.00 | 0.00 | 0.00 |
| | | p-Benzoquinone | 0.00 | 0.00 | 0.00 | 0.00 | 0.00 | 0.00 |
| Physical Property Evaluation | | Viscosity of First Agent (mPa · s) | 55000 | Adhesive | 100 | 35000 | 35000 | 35000 |
| | | | | Separated | | | | |
| | | Viscosity of Second Agent (mPa · s) | 10 | 10 | 10 | 10 | 5 | 20 |
| | | Storage Stability (Viscosity | 1900 | 900 | 940 | 880 | 850 | 770 |
| | | Increasing Rate of Second Agent/%) | | | | | | |
| | | Fixture Time | C | — | A | C | C | A |
| | | Heat Cycle Resistance | D | — | D | D | A | D |

As understood from the results of Tables 1 to 4, it can be found that the adhesives using the compositions in Examples are superior in the fast-curing property and the impact resistance after heat cycle exposure. On the other hand, it can be seen that the adhesives using the compositions of Comparative Examples are inferior in one or more aspects of the fast-curing property and the impact resistance after heat cycle exposure. It can also be seen that the addition of the stabilizer to the second agent can further achieve the effect of suppressing viscosity increase in storage.

### INDUSTRIAL APPLICABILITY

The adhesive using the composition according to the present invention has excellent fast-curing property and heat cycle resistance. The composition according to the present invention can be suitably used as an adhesive in the manufacturing of products that require the fast-curing property and are expected to be used in high temperature environments, for example, and has an industrial applicability.

1. A two-agent type composition consisting of a first agent and a second agent, wherein:
the first agent contains an elastomer, a first acrylic component, a second acrylic component, and a polymerization initiator;
the second agent contains a condensate of amine and aldehyde, a third acrylic component, and a reducing agent;
the first acrylic component is a (meth)acrylate or (meth)acrylic acid, containing two or more hydroxyl groups bonded to a carbon atom in one molecule, or containing one or more functional groups of one or more kind of functional groups selected from a group consisting of an amide group, a cyclic amide group, a sulfoxide group, a ketone group, an aldehyde group, a sulfo group, a sulfino group, a phosphonic group, a sulfobetaine group, a carbobetaine group, and a phosphobetaine group in one molecule;
the second acrylic component is a (meth)acrylate or (meth)acrylic acid other than the first acrylic component; and
the third acrylic component is a (meth)acrylate or (meth)acrylic acid.

2. The composition of claim 1, wherein the condensate of amine and aldehyde is aldehydeaniline.

3. The composition of claim 1, wherein the first acrylic component is a (meth)acrylate or (meth)acrylic acid containing two or more hydroxyl groups bonded to a carbon atom in one molecule, or containing one or more functional groups of one or more kind of functional groups selected from a group consisting of a ketone group, an aldehyde group, a sulfoxide group, a sulfo group, a sulfino group, a sulfobetaine group, a carbobetaine group, a phosphonic group, and a phosphobetaine group in one molecule.

4. The composition of claim 1, wherein a content of the first acrylic component is 10 to 40 parts by mass when a total of the first acrylic component and the second acrylic component is 100 parts by mass.

5. The composition of claim 1, wherein a content of a monofunctional (meth)acrylate or (meth)acrylic acid in the first acrylic component and the second acrylic component is 70 to 100 parts by mass when a total of the first acrylic component and the second acrylic component is 100 parts by mass.

6. The composition of claim 1, wherein a content of the elastomer is 30 to 70 parts by mass when a total of the first acrylic component and the second acrylic component is 100 parts by mass.

7. The composition of claim 1, wherein:
one or more kind of elastomer components contained in the elastomer is a liquid elastomer; and
the liquid elastomer is in a liquid state under an atmosphere at 23° C.

8. The composition of claim 1, wherein the elastomer contains one or more kind of NBRs.

9. The composition of claim 8, wherein the one or more kind of NBRs contains two or more kind of NBRs with different nitrile contents.

10. The composition of claim 1, wherein a nitrile content in the elastomer is 0.001 to 0.300 parts by mass in 100 parts by mass of the elastomer.

11. The composition of claim 1, wherein:
the elastomer contains a core-shell type graft copolymer; and
a content of the core-shell type graft copolymer is 0 to 10 parts by mass when a total of the first acrylic component and the second acrylic component is 100 parts by mass.

12. The composition of claim 1, wherein the elastomer contains a (meth)acryloyl modified elastomer.

13. (canceled)

14. The composition of claim 1, containing 0.001 to 3 parts by mass of a fluorine-containing (meth)acrylate or fluorine-containing (meth)acrylic acid in 100 parts by mass of the third acrylic component.

15. The composition of claim 1, wherein the reducing agent is a transition metal salt.

16. The composition of claim 1, further containing a stabilizer in the second agent.

17. (canceled)

18. The composition of claim 16, wherein the stabilizer contains a stable radical type compound having a stable radical.

19. The composition of claim 18, wherein the stable radical of the stable radical type compound is a nitroxide radical.

20. The composition of claim 18, wherein the stable radical type compound contains at least one kind selected from a group consisting of 1-oxyl-2,2,6,6-tetramethylpiperidine, 4-hydroxy-2,2,6,6-tetramethylpiperidine 1-oxyl, and 4-methacryloyloxy-2,2,6,6-tetramethylpiperidine 1-oxyl.

21. An adhesive containing the composition of claim 1.

22. An adhesive for speakers or an adhesive for motors, containing the composition of claim 1.

23. (canceled)
